(19) United States
(12) Patent Application Publication
(10) Pub. No.: US 2026/0094219 A1
(43) Pub. Date: Apr. 2, 2026

(54) CONGESTION ANALYSIS TOOL

(71) Applicant: Abu Dhabi Company for Onshore Petroleum Operations Limited, Abu Dhabi (AE)

(72) Inventors: Sofia Cruz SOARES, Abu Dhabi (AE); Sultan ALHEMEIRI, Abu Dhabi (AE); Anoop Pappy IDICULA, Abu Dhabi (AE)

(73) Assignee: Abu Dhabi Company for Offshore Petroleum Operation, Abu Dhabi (AE)

(21) Appl. No.: 19/103,887

(22) PCT Filed: Aug. 18, 2022
(86) PCT No.: PCT/IB2022/057748

§ 371 Date: Feb. 14, 2025

(51) Int. Cl. G06Q 50/02; G06F 16/25; G06Q 10/0637

(52) U.S. Cl. CPC G06Q 50/02; G06F 16/254; G06Q 10/06375

(57) ABSTRACT

Congestion analysis tool for facility planning in hydrocarbon reservoirs, comprising a grid selection module, for defining an area of interest and sub-areas thereof; a congestion calculation module, that calculates congestion factors for the predefined area of interest and sub-areas thereof based on spatial data of facility features of a hydrocarbon reservoir; and a scenario module, that enables performing what-if scenarios to improve space management.

### 1. TECHNICAL FIELD

The invention relates to an analysis and planning tool for optimized and automated facility planning in hydrocarbon reservoirs. Particularly the invention relates to a tool for automated calculation, presentation and optimization of congestion in a hydrocarbon field operation.

### 2. PRIOR ART

For the use of hydrocarbon reservoirs, like natural oil or gas reservoirs, various technical facilities are required during the various stages of production. First drilling facilities and roads are necessary to reach the hydrocarbon reservoir. Then production facilities are used to retrieve the oil and gas from the reservoirs and to transport the product to further processing facilities.

Such facilities, particularly roads, pipelines or over head lines (OHL), require and occupy space and may prevent other facilities to be constructed. Thus, space is limited and production planning has to consider the space requirements of any kind of facilities which contribute to congestion of a particular area.

Congestion implies total occupation of space in a particular area of interest (AOI). More land use will lead to higher congestion, meaning the free space for future utilization is reduced. Therefore, there is a need to evaluate the most optimum route networks, like pipelines, over head lines (OHL), roads etc. considering accessibility and space availability limitations in an area of interest. Basically, congestion may be measured as a factor on how easy it is to go from one AOI to another AOI.

Presently, the space requirement impacts and congestion of various development options are only evaluated by manual analysis via a Geographic Information System (GIS). Such manual analysis highly depends on the person who evaluates it. In addition, manual evaluations were highly time consuming, abstract and not fully visual or understandable by stakeholders. Further, they are very difficult to support, particularly when the option that least contributes to the increase of area congestion is the one with a higher initial investment. Moreover, the real impact on accessibility to an area affected by the chosen route for facilities, like pipelines, over head lines or roads, remains unknown.

Therefore, there is a need for a congestion planning tool that supports optimum footprint management, to plan the best location for the future facility and to route future networks, particularly pipelines, over head lines (OHL), roads, etc.

### 3. SUMMARY OF THE INVENTION

The above-mentioned problem is solved by a congestion analysis tool for facility planning in hydrocarbon reservoirs according to claim 1.

Preferably, the above-mentioned problem is solved by a congestion analysis tool for facility planning of hydrocarbon reservoirs, comprising a grid selection module, for defining an area of interest and sub-areas thereof, a congestion module, that calculates congestion factors for the predefined area of interest and sub-areas thereof based on spatial data of facility features and a scenario module that enables performing what-if-scenarios to improve space management.

The tool integrates a combination of numerous automated process that ensure accurate data collection, processing, implementation of specific business rules & calculation of the congestion factor that will assist in better decision making and perform informed decision in space management of facility planning in hydrocarbon reservoirs.

The congestion factor tool is a tool to automatically calculate and visualize the amount of occupied space in a defined area helping at planning and analysis stage. The calculation is area based which is a ratio calculated based on the empty space available in a grid (not occupied by any physical infrastructure). The tool preferably comprises a whole set of automated process to ensure the correct data and policies are implemented before the congestion factor is calculated. These principles and the modules come together to complete the tool. The congestion factor tool is able to compute the congestion in an area of interest (AOI). The congestion factor tool enables the user to understand the actual congestion and to perform what if scenarios in order to allow for optimized and automated facility planning in hydrocarbon reservoirs.

With the grid selection module, the user can select an AOI and thereby defines sub-areas of the AOI that are individually evaluated in terms of congestion. The user may select the grid area of interested he/she is interested in calculating the congestion, for example a group of wells and the related processing station.

The congestion calculation module reads in all features, i.e. the infrastructure, within the AOI based within the grid and based on preprocessed parameters. Then, the congestion calculation module allocates spatial data, like 2D-or 3D-shape, footprint, size or dimensions, to all features within the area of interest to form or contribute to a congestion model of the AOI. Then congestion calculation module calculates a congestion factor preferably for each sub-area or grid-tile of the AOI. This calculation is based on the congestion model generated. Particularly, the congestion calculation module will determine the congestion factor by calculating how much of free area is available within the grid. This congestion factor is stored as a result to the attributes of the grids graphic. Also based on this congestion factor, a default symbology, for example a specific color per congestion factor, will be applied to the graphic for visual representation of the congestion.

The scenario module enables performing what-if scenarios to improve space management in hydrocarbon reservoirs. For example, the user can add additional infrastructure, such as new corridors, proposed wells, pads or even pipelines. The congestion analysis tool then re-calculates the congestion factor and provides an indication of various scenarios for the end user. The scenario module provides the information the end user needs to perform an informed decision. The scenario module supports footprint management decision making quantitatively from congestion perspectives by providing different location and routing proposals and comparing them. It also improves the efficiency of analysis, since usually new projects are focused on reducing their cost, and the nearest location is the frequently the preferred one. However, this nearest location may not be the most convenient one in terms of congestion or business continuity and other options that need to be considered. To achieve optimum footprint management, the best location for the future facility and route for future networks (pipelines, over head lines (OHL), roads, etc.) can be selected using the congestion analysis tool as it provides a congestion factor in a quantifiable manner.

Preferably, the congestion analysis tool further comprises a data collection module, for collecting source data for the congestion analysis. Source data, such as CAD drawings and survey data, but also data from other sources can be collected for the analysis using the data collection module.

Preferably, the congestion analysis tool further comprises a QC module, that performs an automated quality control on source data. Automated quality control algorithms ensure that data standards and specifications are met. These standards are various, such as valid coordinates, valid geometry (normal topology rules such as no open-ended features for pipelines), connection factors (for example a pipeline has to start at some predefined features and end at predefined features) and the like. These standards are documented and have been gathered after numerous studies conducted within the organization.

Preferably, the congestion analysis tool further comprises an ETL module, that performs automated transformation and conversion of data. This ensures that data from different sources can be commonly used for the congestion analysis. This transformed and converted data can be stored within a common corporate database and/or in various business databases.

Preferably, the congestion analysis tool further comprises a HSE module, that performs an automated data preparation based on predefined health and safety environment (HSE) principles. The HSE module can analyze data after processing by the ETL module and can add a geometric buffer around the features, depending on the necessary safety distances around the particular feature. Thereby the HSE module creates the resulting data based on HSE principles.

Preferably, the congestion analysis tool further comprises business rules module, that comprises a union algorithm to provide a unified polygon from the spatial data of the features within the AOI. The business rule module can preferably perform a union algorithm on the buffered geometric feature data after processing by the HSE module to create a unified polygon.

Using these modules, the congestion analysis tool reads all the features that are available in the database after the automated ETLs and quality control procedures are complete. The features are buffered in databases using spatial tools based on predefined parameters specific to the industry. For example, based on HSE policies implemented within the organization, for safety reasons, all gas pipelines should have a corridor of 2 meters on each side. This means, all gas pipelines have to be added a geometric buffer of 2 meters. The resulting congestion element for this feature is considered in following creation of a unified polygon.

When forming the unified polygon, the buffered spatial objects are dissolved and the unified polygon is generated as a single object that combines all geometric dimensions of the congestion elements. Thus, the unified polygon geometrically quantifies all the parameters that are required for the congestion calculation of the AOI.

This unified polygon along with the grid elements are processed to calculate the congestion factor for each grid element. This is particularly done by identifying the gaps of the grid when the single object is cut using the grid as an overlay. The congestion factor is a ratio that denotes how much of the grid is free. The congestion factor tool uses geometric and semantic data of the hydrocarbon site to be planned. Therefore, such data will need to be integrated and established. All as-built drawings are converted and stored in a GIS database and forms a so-called corporate database. In addition to this, the future planned site data, e.g. pads, wells etc. are digitally available in the corporate database as well. Further, by means of established service level agreement (SLA) and governance principles it is ensured that the data is update and accurate.

The tool will then calculate the congestion factor for each grid and stores this congestion factor in the database for each grid.

Preferably, the congestion analysis tool is implemented as add-in of a commercial GIS software for example ArcGIS Desktop. Thus, the overall environment of a GIS software, like UI, internal model and graphic representation and further features of the GIS software can be used. The congestion analysis tool is developed as an add-in to ArcGIS desktop. There are defined ArcMap projects that are pre-saved and loaded to execute the congestion analysis tool. Once the congestion analysis tool is executed, it reads all the data in the loaded project and generates a single polygon from all the features in the project. This single polygon encompasses all the existing and planned infrastructure, including safety buffers for the infrastructure.

Preferably, the congestion factor is associated to each sub-area of the area of interest in form of a congestion attribute of an element, particularly as a factor, a percentage or a color coding. Thus, for each sub-area or grid tile of the area of the AOI the associated congestion factor can be easily recognized, and different design alternatives can easily be compared. There is predefined symbology for the representation of the congestion factor as grids. These can be set up as per the requirements of the user.

Preferably, the congestion attribute is labelled and/or displayed within the GIS software. The symbology of the congestion attribute of a sub-area can be preferably controlled by the already existing functionalities of the GIS software.

Preferably, the congestion attribute is exportable as numerical spreadsheet, particularly as Microsoft Excel file.

Preferably, the HSE module applies a buffer as defined by health, safety and environment (HSE) principles safety distance table to all applicable features within the AOI. Thus, not only the actual dimensions and shape of the features within the AOI is considered by the congestion analysis tool but also any safety distance required around certain features, e.g. around potentially dangerous features, like hydrocarbon tanks or hydrocarbon pipelines. In planning the field, HSE defines safety buffers for all features in the field. For example, two oil wells have to be at minimum 80 meters apart or two flowlines should be at minimum 1 meter apart. The congestion factor tool reads all the concerned data in the corporate database and perform automated buffering of related features. This data is processed and stored in a database as temporary data that is read by the congestion factor tool when calculating the congestion factor.

Preferably, the safety distances are based on the H₂S concentration of a well or feature in question. This reduces the risks of an explosion of the feature.

Preferably, the congestion analysis tool supports map layers that can be included into the congestion calculation. Thus, the user can easily show or hide features of interest on different layers.

Preferably, the congestion analysis tool supports selecting of certain model features such that these model features are ignored for the congestion calculation.

Preferably, the congestion analysis tool comprises a database of spatial data of facility features. Thus, the spatial data is already known to the tool and must not be entered manually.

Preferably, the congestion analysis tool comprises a database of historic congestion analyses. Thus, the congestion analysis tool may learn from historic analyses and may suggest design alternatives from already implemented projects.

### 4. SHORT DESCRIPTION OF THE DRAWINGS

In the following, preferred embodiments of the invention are disclosed by reference to the accompanying figures, in which shows:

FIG. 1: a schematic view of a preferred embodiment of a congestion analysis tool according to the invention;

FIG. 2 a schematic diagram of the data preparation process for a congestion analysis;

FIG. 3 a schematic diagram of the congestion analysis process; and

FIGS. 4A-D a schematic example of a congestion analysis for facility planning in hydrocarbon reservoirs.

### 5. DESCRIPTION OF PREFERRED EMBODIMENTS

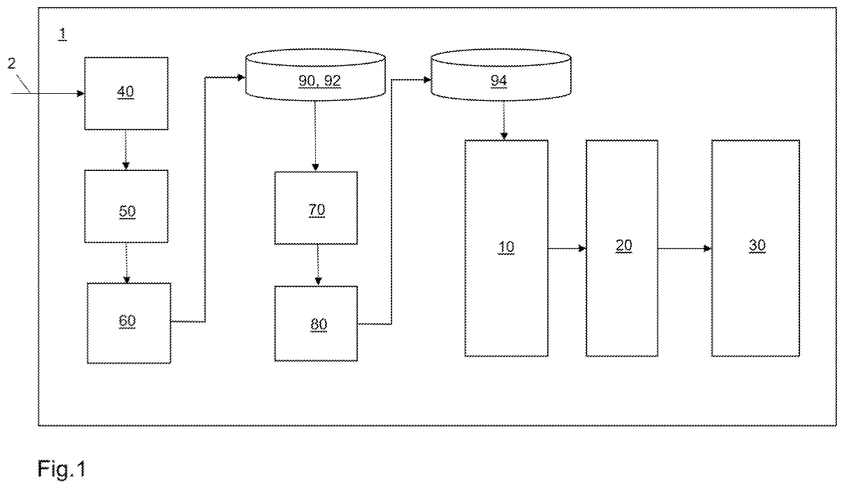

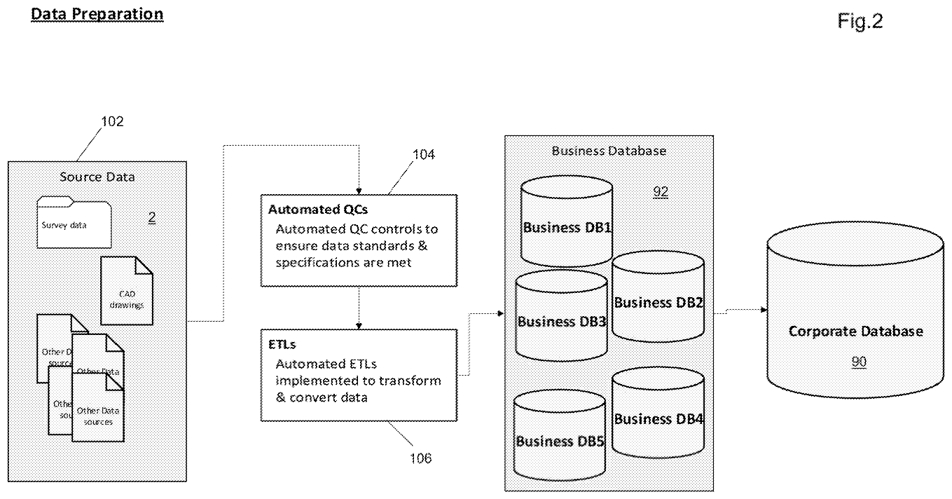

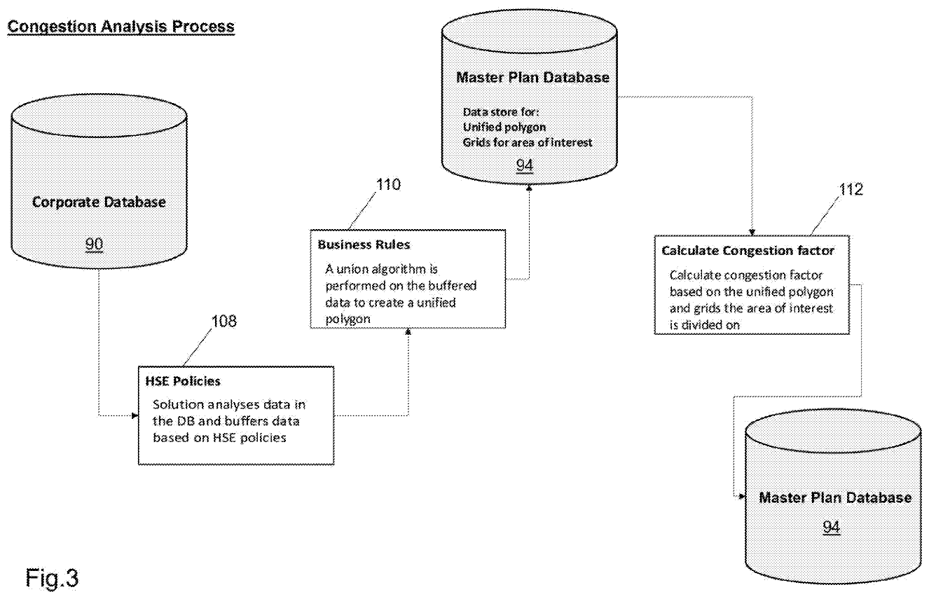

In the following preferred embodiments of the invention are described with respect to the figures. FIG. 1 shows an exemplary structural overview over a congestion analysis tool, FIG. 2 shows exemplary process steps of the data preparation and FIG. 3 shows exemplary process steps of the congestion analysis process.

The congestion analysis tool 1 is a tool to automatically calculate and visualize the amount of occupied space in a defined area helping at planning and analysis stage. As shown in the figures, the congestion analysis tool 1 preferably comprises a whole set of automated process'to ensure the correct data and policies are implemented before the congestion factor is calculated. These principles and the modules come together to complete the congestion analysis tool.

As shown in FIG. 1 the congestion analysis tool 1 comprises a grid selection module 10 a congestion calculation module 20, a scenario module 30, a data collection module 40, a quality control module 50, an ETL module 60, an HSE module 70 and a business rule module 80. The congestion analysis tool 1 comprises or has data links to a corporate database 90 and a master plan database 100. Further modules and databases may also be used.

The grid selection module 10 is used to define an area of interest and sub-areas thereof. Congestion for the field is outlined based on a pre-defined grid. For example, a 2×2 km grid can be chosen as the reference considering a hydrocarbon field that has an area over 1000 sq km.

The congestion calculation module 20 allocates spatial data of facility features within the area of interest to a congestion model and then calculates of a quantified congestion factor for sub-areas of the area of interest from the congestion model.

By the scenario module 30 the user can perform what-if scenarios to improve space management.

The congestion analysis tool 1 is designed to be simple and effective. For accurate results, the data should be accurate and representation of the actual scenario in the field. There are established workflow and processes in place to ensure this is done.

The user can use the data collection module 40 to collect source data 2 needed for the actual congestion analysis (step 102). Such source data can comprise CAD drawings, survey data, but also data from other sources, see FIG. 2.

This source data then undergoes an automated quality check (QC) in the QC module 50 to ensure that the data is coherent and consistent (step 104).

After that the quality-checked data is then provide to an ETL module 60 (ETL =extract, transform and load) to undergo a data integration process that combines data from multiple data sources into a single, consistent data store that is loaded into corresponding business databases 92 and/or the corporate database 90 (step 106).

The so stored data in the databases 90, 92 is then analyzed by the HSE module 70 and applies a geometric safety buffer to the used features according to a HSE principles safety table (step 108).

After that in a business rules module 80 a union algorithm is applied to the spatial data of the features to provide a unified polygon from the spatial data (step 110). The so obtained data is stored within the master plan database 94 that also stores the sub-areas or grids for the area of interest selected by the grid selection module 10.

Finally, the congestion factor is calculated by the congestion calculation module 20 based on the unified polygon and grids, into which the area of interest is divided in (step 112). In combination with the scenario module 30 and the congestion calculation module 20 the user can perform what-if scenarios. Thereby, different layout options are calculated and can be compared concerning the congestion generated. Thus, the layout of the hydrocarbon reservoir and its facilities can be optimized.

For the user of the congestion analysis tool 1, the process of congestion analysis and optimization is very convenient. After loading a project in a commercially available GIS tool, for example ArcMap or ArcGIS, the user will just need to start the congestion analysis tool 1 by selecting “Calculate congestion factor” and the process of calculation will be initiated, as outlined above. Depending on the grid structure and if the process includes additional what-if scenarios digitized on the map, the processing will take additional time. The results will be updated as a value in the database and this information will be updated with each process.

A preferred process the user employs to execute the congestion analysis tool 1 has the following steps:
The user opens a saved project that preferably has all the necessary data layers saved.
The user then selects the grid(s) that he/she wishes to process the congestion factor for.
If the user has additional layers that he/she wishes to include in the calculation, it may be added to the project and processed.
If the user wishes to ignore certain features, for example a planned corridor, the user can select this feature and it be ignored for the calculation.
The user then starts the congestion analysis processing.

By the congestion analysis tool 1 user is able to select a specific grid and the tool will calculate the congestion of that area.

Further the user can specify a random area for the tool to calculate the congestion factor, for instance field boundary, restriction zones boundary, processing areas exclusion zone, etc.

Further the user can create additional features to be included in the factor computation to assist in calculation of what-if scenarios

And finally, the user can have the result presented as an attribute in the field and a report stating the beakdowns/percentage of all the features that contribute to the congestion.

The congestion analysis tool 1 preferably performs a colour coding of the congestion values based on a slab that is reflected on the field map after computation. Preferably the colour coding can be for a congestion factor up to 0-15% dark green color, congestion factor 15-30% light green, congestion factor 30-45 % yellow, congestion factor 45-60% amber and congestion factor 60-100% red. This visualization of the computed congestion factor enables management and asset study teams to immediately tackle the field areas that have amber and red colors and initiate projects for decongestion.

This congestion analysis tool 1 particularly provides:
Better and quicker decision making.
Involving planning in early stages of projects from Assess and Select phase.
Comparing design proposals (option selection) by giving quantity congestion factors.
Identification of congested areas that have future development plans and initiating projects for decongestion to take a proactive action to ensure business continuity.
Increase stakeholder awareness regarding the field congestion to seek more supports in our business plan for future development.
Reduced costs & time due to pro-active approach.
Can be extended to other fields.
Identification of data gaps that need resolution to enhance the critical data management.

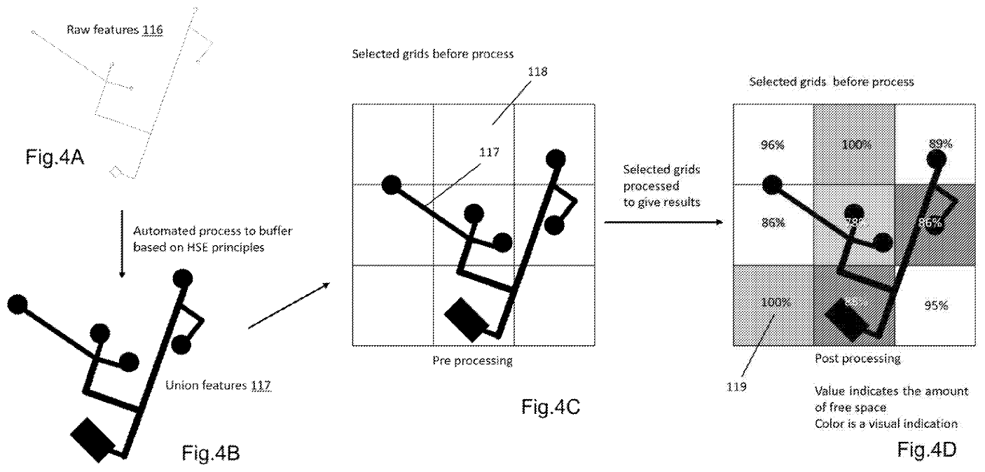

FIGS. 4A-D provide an example of a congestion analysis for facility planning in hydrocarbon reservoirs with the congestion analysis tool 1.

FIG. 4A shows geometric data of raw features 116 of a hydrocarbon production facility. In the shown example the features 116 comprise a collection of wells, small circles, which are connected by pipelines, represented by lines, to a processing station, represented by a square. These raw features data 116 is processed through the automated quality control by the QC module 50. This automated quality control ensures certain rules, such as the rule that the wells have pipelines connected and that the pipelines follow the defined corridor to the processing plant.

These raw features are added a geometric buffer based on the HSE principles by the HSE module 70 as shown in FIG. 4B. Further, the unified polygon 117 is generated out of the buffered features, by the business rules module 80.

The user can then overlay grids 118 of an AOI by means of the grid selection module 10 as shown in FIG. 4C. The user can then select the grids which should be processed by the congestion analysis tool 1.

The congestion calculation module 20 will examine each grid 118, identify how much of the area of the grid 118 is populated by the unified polygon 117 and then calculate what percentage of free area is available in the grid 118. Based on this calculation the congestion calculation module 20 determines the congestion factor of each grid 118. This congestion factor is then visualized for each grid 118 as grid color and/or as percentage of free space 119 of each grid.

This calculation and visualization are then be used for performing what-if scenarios by the scenario module 30 and the congestion calculation module 20 to perform an optimal space management of the hydrocarbon facility.

1. A congestion analysis tool for facility planning in hydrocarbon reservoirs, comprising:
a. a grid selection module for defining an area of interest and sub-areas thereof;
b. a congestion calculation module, that calculates congestion factors for the predefined area of interest and sub-areas thereof based on spatial data of facility features of a hydrocarbon reservoir; and
c. a scenario module, that enables performing what-if scenarios to improve space management.

2. The congestion analysis tool according to claim 1, further comprising a data collection module, for collecting source data for the congestion analysis.

3. The congestion analysis tool according to claim 1, further comprising a QC module, that performs an automated quality control on source data.

4. The congestion analysis tool according to claim 1, further comprising an ETL module, that performs automated transformation and conversion of data.

5. The congestion analysis tool according to claim 1, further comprising a HSE module, that performs an automated data preparation based on predefined health and safety environment (HSE) principles.

6. The congestion analysis tool according to claim 1, further comprising a business rules module, that comprises a union algorithm to provide a unified polygon from the spatial data.

7. The congestion analysis tool according to claim 1, wherein the congestion analysis tool is implemented as add-in of a commercial GIS software.

8. The congestion analysis tool according to claim 1, wherein the congestion factor is associated to each sub-area of the area of interest in form of a congestion attribute of an element, particularly as a factor, a percentage or a color coding.

9. The congestion analysis tool according to claim 1, wherein the congestion attribute is labelled and/or displayed within the GIS software.

10. The congestion analysis tool according to claim 1, wherein the congestion attribute is exportable as numerical spreadsheet, particularly as Microsoft Excel file.

11. The congestion analysis tool according to claim 1, wherein the HSE module applies a buffer as defined by a HSE principles safety distance table to all applicable features within the area of interest (AOI).

12. The congestion analysis tool according to claim 11, wherein the safety distances are based on the H₂S concentration of a well or feature in question.

13. The congestion analysis tool according to claim 1, wherein the congestion analysis tool supports map layers that can be included into the congestion calculation.

14. The congestion analysis tool according to claim 1, wherein the congestion analysis tool supports selecting of certain model features such that these model features are ignored for the congestion calculation.

15. The congestion analysis tool according to claim 1, further comprising a database of spatial data of facility features and/or a database of historic congestion analyses.
